(19) United States
(12) Patent Application Publication
(10) Pub. No.: US 2014/0181065 A1
(43) Pub. Date: Jun. 26, 2014

(54) Creating Meaningful Selectable Strings From Media Titles

(71) Applicant: Microsoft Corporation, Redmond, WA (US)

(72) Inventors: Vijayaraghavan Kalyanapasupathy, Sammamish, WA (US); Jimmy Yu Wu, Bellevue, WA (US); Matthew Wayne Gertz, Snohomish, WA (US); Craig Osborne, Issaquah, WA (US)

(73) Assignee: MICROSOFT CORPORATION, Redmond, WA (US)

(21) Appl. No.: 13/721,410

(22) Filed: Dec. 20, 2012

(51) Int. Cl. G06F 17/30

(52) U.S. Cl. CPC G06F 17/30864
USPC 707/706; 707/728

(57) ABSTRACT

A method and medium are provided for generating shortened media titles. The length of a media title is constrained by the physical space allotted to it on a display device. Interfering and inaudible portions are removed from the media title. The media title is then split at join phrases in order to create multiple substrings. The multiple substrings are ranked according to relevance and audibility. The highest ranked substring is either stored or displayed.

### BACKGROUND

A user can search for media content with the aid of a keyboard or a speech recognition device. However, the resulting titles returned can sometimes be too long to display, too obtuse to understand, or too hard to pronounce. Titles that are too long cannot be accommodated by the limited space a screen allots to displaying media titles. Long titles also run the risk of being mis-spoken by the user or misunderstood by a speech recognition device. Simply truncating long titles, however, carries the danger of producing gibberish or even obscenity.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the present invention describe intelligently creating meaningful shortened titles whenever brevity is required while maintaining intelligibility, uniqueness, and audibility. Brevity is important because titles sometimes need to meet a length threshold that is commensurate with the size of the screen allotted to displaying media titles. In addition, brevity enhances the likelihood that a title will be understood by a speech recognition device when read aloud by the end-user. Generally speaking, the length of a speech command is directly proportional to the error rate of speech recognition. Intelligibility is maintained during the shortening process such that the end-user not only understands the meaning of the shortened title itself but also knows the media content to which the shortened title refers. The shortened title should also be unique and distinguishable from other titles in the same catalog or on the same screen thereby decreasing the likelihood that a user or a speech recognition device will confuse one title for another. Finally, audibility refers to the end-user's ability to speak and the speech recognition device's capacity to understand the shortened title. Unpronounceable characters or symbols are eliminated in order to make the shortened title audibly unambiguous.

Embodiments of the present invention first read in a media title along with its associated cultural information. The system assigns the title to a bucket according to the associated cultural information. The title is then processed through a fuzzy filter that removes inaudible and interfering portions from the title. The system identifies join phrases in the title and recursively splits the title into successively shorter substrings until the last substring no longer contains any join phrases. The system ranks the resulting substrings using one or more of length threshold, relevance criteria, and audible criteria. The highest ranked string will be the most relevant string to the original meaning of the title, within the length threshold, or audibly clear to a speech recognition device. The system processes the highest ranked substring to remove any special characters or extraneous phrases before displaying it to the end user or storing it.

### BRIEF DESCRIPTION OF THE DRAWINGS

Embodiments of the invention are described in detail below with reference to the attached drawing figures, wherein:

FIG. 1 is a block diagram of an exemplary operating environment suitable for implementing embodiments of the invention;

FIG. 2 is a diagram of an exemplary operating environment for generating shortened titles, in accordance with an embodiment of the present invention;

FIG. 3 is a block diagram of an exemplary system according to an embodiment of the present invention;

FIG. 4 is a flowchart depicting the process of fractal splitting according to an embodiment of the present invention;

FIG. 5 is a line drawn representation of a graphical image depicting a system displaying shortened titles, in accordance with an embodiment of the present invention;

FIG. 6 is a flow chart showing an exemplary method for generating meaningful shortened titles, in accordance with an embodiment of the present invention;

FIG. 7 is a flow chart showing an exemplary method for generating audibly intelligible shortened titles, in accordance with an embodiment of the present invention; and

FIG. 8 is a flow chart showing an exemplary method for dynamically generating meaningful shortened titles, in accordance with an embodiment of the present invention.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Overview of Generating Shortened Titles

Embodiments of the present invention describe intelligently creating meaningful shortened titles whenever brevity is required while maintaining intelligibility, uniqueness, and audibility. Brevity is important because titles sometimes need to meet a length threshold that is commensurate with the size of the screen allotted to displaying media titles. In addition, brevity enhances the likelihood that a title will be understood by a speech recognition device when read aloud by the end-user. Generally speaking, the length of a speech command is directly proportional to the error rate of speech recognition. Intelligibility is maintained during the shortening process such that the end-user not only understands the meaning of the shortened title itself but also knows the media content to which the shortened title refers. The shortened title should also be unique and distinguishable from other titles in the same catalog or on the same screen thereby decreasing the likelihood that a user or a speech recognition device will confuse one title for another. Finally, audibility refers to the end-user's ability to speak and the speech recognition device's capacity to understand the shortened title. Unpronounceable characters or symbols are eliminated in order to make the shortened title audibly unambiguous.

Embodiments of the present invention avoid a bottleneck in the content ingestion process because no contextual information is needed, which lends embodiments to both client and server implementations. The algorithm utilized may be deterministic and require no learning phase or supervision in order to be implemented. In addition, the algorithm can be modified and extended in a variety of ways to produce lower error rates with little added complexity or degradation in processing speed. Moreover, the algorithm can also be extended to other languages.

Embodiments of the present invention first read in a media title along with its associated cultural information. The system assigns the title to a bucket according to the associated cultural information. The title is then processed through a fuzzy filter that removes inaudible and interfering portions from the title. The system identifies join phrases in the title and recursively splits the title into successively shorter substrings until the last substring no longer contains any join phrases. The system ranks the resulting substrings using one or more of length threshold, relevance criteria, and audible criteria. The highest ranked string will be the most relevant string to the original meaning of the title, within the length threshold, or audibly clear to a speech recognition device. The system processes the highest ranked substring to remove any special characters or extraneous phrases before displaying it to the end user or storing it.

In one aspect, a method of generating for display a meaningful shortened title is provided. The method comprises receiving a title of a media content from a catalog and identifying one or more interfering portions of the title according to a cultural information associated with the title The method also comprises removing the one or more interfering portions from the title and identifying in the title one or more join phrases that connect two or more significant portions of the title together. The method further comprises splitting the title at the one or more join phrases into one or more sub-strings according to a join limiter, which is a predefined rule that prevents splitting at certain join phrases. Still further, the method comprises ranking the one or more sub-strings according to a relevance criteria and a predetermined length threshold, and storing for display a highest ranked sub-string as a shortened title.

In another aspect, a method of generating an audibly intelligible shortened title for issuance as a command to a speech recognition device is provided. The method comprises receiving a title of a media content from a catalog and identifying in the title one or more join phrases that connect two or more significant portions of the title together. The method also comprises splitting the title at the one or more join phrases into one or more sub-strings and ranking the one or more sub-strings according to an audible criteria and a predetermined length threshold. The method further comprises storing for display a highest ranked sub-string as a shortened title.

In yet another aspect, a method of generating a meaningful shortened title is provided. The method comprises receiving a search query from a computing device having display characteristics and sending the search query to a catalog or an external search engine. The method also comprises receiving search results comprising one or more media titles from the catalog or the external search engine and determining a threshold display length for media titles based on the display characteristics. The method further comprises identifying in the title one or more join phrases that connect two or more significant portions of the title together and splitting the title at the one or more join phrases into one or more substrings. Still further, the method comprises selecting a substring from the one or more substrings according to a selection criteria and the threshold display length, and outputting for display the selected substring as a shortened title.

Having briefly described an overview of embodiments of the invention, an exemplary operating environment suitable for use in implementing embodiments of the invention is described below.

### Exemplary Operating Environment

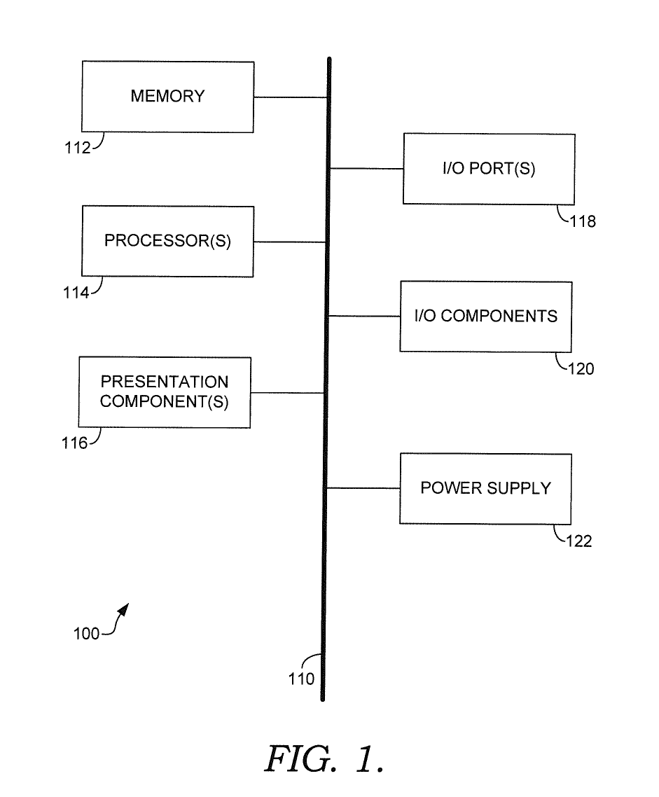

Referring to the drawings in general, and initially to FIG. 1 in particular, an exemplary operating environment for implementing embodiments of the invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component 120. Also, processors have memory. The inventors hereof recognize that such is the nature of the art, and reiterate that the diagram of FIG. 1 is merely illustrative of an exemplary computing device that can be used in connection with one or more embodiments of the invention. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and nonremovable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory 112 may be removable, nonremovable, or a combination thereof. Exemplary memory includes solid-state memory, hard drives, optical-disc drives, etc. Computing device 100 includes one or more processors 114 that read data from various entities such as bus 110, memory 112 or I/O components 120. Presentation component(s) 116 present data indications to a user or other device. Exemplary presentation components 116 include a display device, speaker, printing component, vibrating component, etc. I/O ports 118 allow computing device 100 to be logically coupled to other devices including I/O components 120, some of which may be built in. Illustrative I/O components 120 include a microphone, joystick, game pad, satellite dish, scanner, printer, wireless device, etc.

### Exemplary Operating Environment for Generating Shortened Titles

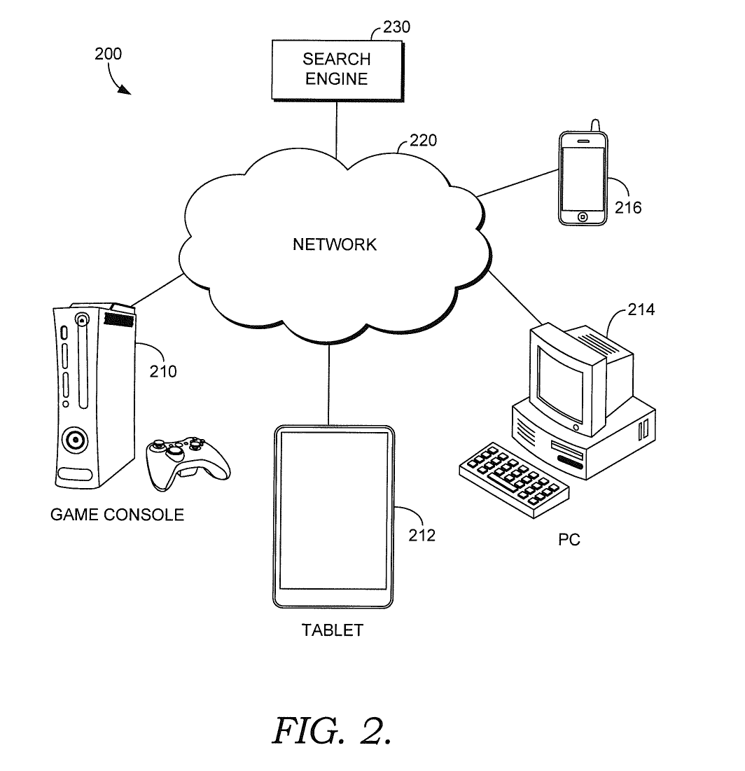

Turning now to FIG. 2, an integrated search environment 200 is shown, in accordance with an embodiment of the present invention. The environment 200 comprises various computing devices connected through a network 220 to a search engine 230. Exemplary computing devices include a game console 210, a tablet or slate 212, a personal computer 214, and a mobile phone 216. Use of other computing devices, such as smart phones and GPS devices, are also possible.

The game console 210 may have one or more game controllers communicatively coupled to it. In one embodiment, the tablet 212 may act as an input device for a game console 210 or a personal computer 214, while running the same application simultaneously. In another embodiment, the tablet 212 is a stand-alone application client. Network 220 may be a wide area network, such as the Internet. In one embodiment, shortened titles are pushed to the game console or PC and then to a connected device. The shortened titles may be generated through embodiments of the invention by client applications. For example, a client application connected to a media server may use embodiments of the invention to shorten titles presented to the user.

The search engine 230 may utilize embodiments of the present invention to generate shortened titles. Other devices may generate shortened content titles from longer titles received from the search engine 230. Search engine 230 may comprise multiple computing devices communicatively coupled to each other. In one embodiment, the search engine 230 is implemented using one or more server farms. The server farms may be spread out across various geographic regions including cities throughout the world. In this scenario, the clients may connect to the closest server farms. Embodiments of the present invention are not limited to this setup.

The search engine may be accessed via the Internet through a search home page. The search engine will present a search results page in response to a query. Embodiments of the present invention may access the search engine functionality through an application program interface (“API’) provided by the search engine. Essentially, this API allows an application to submit a query directly, without going through the search home page. The search results may also be returned directly to the requesting device without display on a search results page.

### Algorithm for Generating Shortened Titles

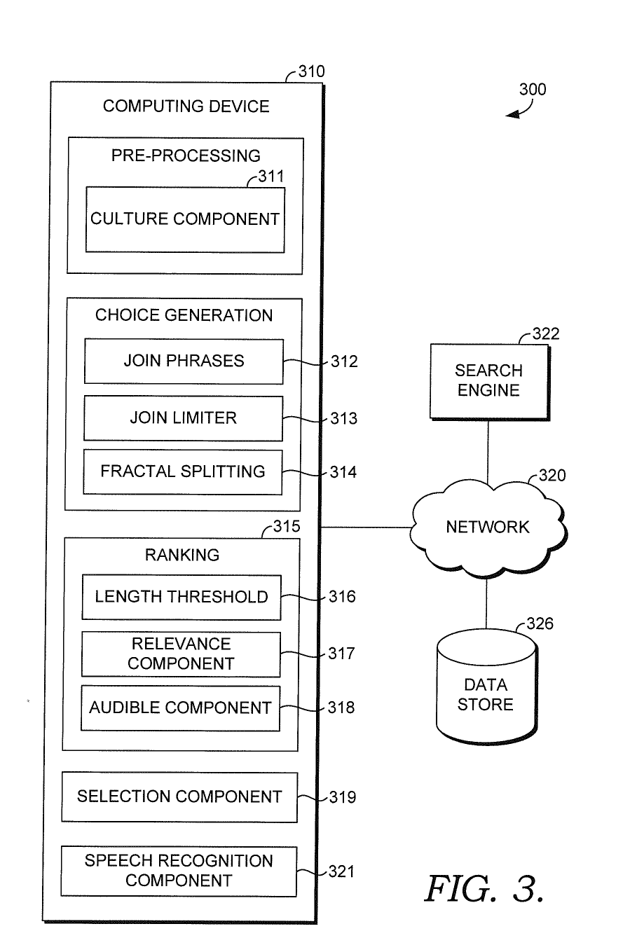

Turning now to FIG. 3, a block diagram is illustrated, in accordance with an embodiment of the present invention, showing a system 300 configured to generate or store shortened versions of full media titles. The system 300 shown in FIG. 3 is merely an example of one suitable computing system environment and is not intended to suggest any limitation as to the scope of use or functionality of embodiments of the present invention. Neither should the system 300 be interpreted as having any dependency or requirement related to any single component or combination of components illustrated therein. Further, the system 300 may be provided as a stand-alone product, as part of a software development environment, or any combination thereof.

The system 300 includes one or more computing devices 310, a search engine 322, and one or more data stores 326, all in communication with one another. In embodiments, a network 320 is provided to facilitate communication between computing device 310 and search engine 322. Network 320 may be wireless and may include, without limitation, one or more local area networks (LANs) and/or wide area networks (WANs). Such networking environments are commonplace in offices, enterprise-wide computer networks, intranets, and the Internet.

The computing device 310 is any computing device, such as the computing device 100. For example, the computing device 310 might be a personal computer, a laptop, a slate, a server computer, a wireless phone or device, a personal digital assistant (PDA), among others. Additionally, the computing device 310 may further include a keyboard, keypad, stylus, joystick, touch screen, speech recognition device, and any other input component that allows a user to access wired or wireless data on the network 320. It should be noted, however, that the present invention is not limited to implementation on such computing devices 310, but may be implemented on any of a variety of different types of computing devices within the scope of embodiments hereof. In an embodiment, a plurality of computing devices 310, such as thousands or millions, are connected to network 320.

In an embodiment of the present invention, an algorithm for generating shortened media titles contains four phases. The algorithm may begin with reading in the entire media catalog available to the customers on a particular system such as Xbox Live or Netflix for processing and storage. Alternatively, the algorithm may dynamically respond to a user's query and read in one title at a time for processing and display.

The first phase is preprocessing which uses culture component 311 to read in the media title along with its associated cultural information. The cultural information can be gathered from a variety of sources such as metadata or the Internet via an external search engine. A wealth of information may be found in the metadata that can be used to divine the cultural affiliation of the media title. Alternatively, the culture component 311 is linked to an external search engine 322 on the back-end of the computing system via network 320. The culture component 311 inputs a query into the search engine for a particular media title and search the returns results for cultural affiliation.

The culture component 311 assigns each media title to a bucket according to the title's cultural information. Each culture bucket has a set of pre-identified interfering or inaudible portions. Culture component 311 removes interfering or inaudible portions from media titles. Inaudible portions of a title detract from the audible qualities of the title by presenting characters or symbols that cannot be pronounced. Interfering portions of a title contain redundant information that does not add to the understanding of the title. In addition, interfering portions might cause confusion or ambiguity. The culture component 311 can determine which portion rises to the level of interference by mining the metadata or the Internet. For instance, for a music track traits in the metadata may contain cheerful, romantic, jazz music, 60s, duet, violin, etc. Culture component 311 searches for other media titles in the same catalog that contain comparable metadata traits. The metadata of these related media titles can illuminate which portions of the media title in question are interfering.

In addition, an Internet search like the one described above with respect to cultural association can be implemented to aid in determining interfering portions. For instance, in the U.S. culture, the string “$9,00” contains a comma that is interfering because it has no inherent meaning in the present context and merely functions to lengthen the title and cause confusion. Indeed, the viewer cannot be sure whether the string is nine dollars or nine hundred dollars. However, in the Chinese culture, a comma doubles as a decimal point in the currency context. Therefore, culture component 311 would remove the comma from the string in the U.S. culture bucket, but refrain from doing so if the same string were present in a Chinese culture bucket.

By way of another example is the media title “('95) *Saved by the Bell (Cla$$ Dismissed).” The portion “('95)” is interfering because it represents the year in which the movie was released which information is already a part of the metadata associated with the movie. The portions “*”, “(”, and “)” are inaudible because they cannot be verbalized. Other examples of inaudible or non-pronounceable characters include: !, “ ”, [ ], < >, / \, etc. Inaudible characters are usually removed unless an exception arises. For instance, “:” is removed unless it appears in the context of time such as “10:00 A.M.” Another example is that “/” is usually removed unless it appears in the context of a date such as “11/30/12.” A further example is that “.” is usually removed unless it appears as part of a number such as “Jackass 3.5” or “The $178.92 Movie.”

Also in the above example, the portion “Cla$$ Dismissed” is significant because it is part of the title, but contains portions that interfere with pronunciation, namely “$$.” Due to the prevalence of instant messaging via applications like MSN and text messaging via mobile phones, abbreviations have entered the common lexicon. The culture component 311 is equipped with a list of abbreviations/emoticons and their proper counterparts. For instance, “txt” will be rewritten as “text,” “:-)” as “happy face,” “@” as “at,” and etc. Additionally, an abbreviation or symbol might carry different meanings in different cultural contexts. For example, depending on context, “$” could mean “s” or dollar sign. Similarly, “@” could mean “at” or “a.” Accordingly, the culture component 311 removes the interfering and inaudible portions and modifies the inaudible but significant portions resulting in “Saved by the Bell Class Dismissed” being stored or displayed.

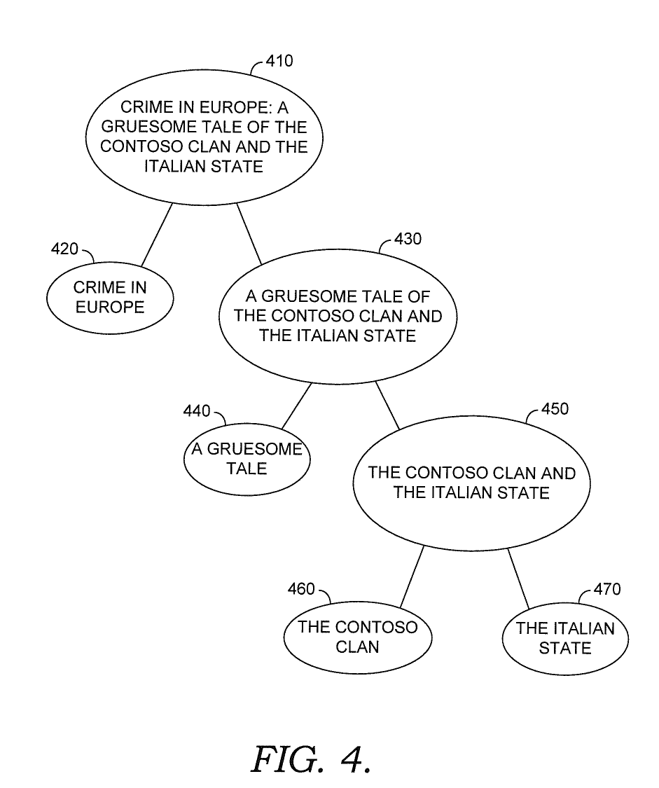

With continued reference to FIG. 3, the next phase in the algorithm is choice generation. This phase generates different variations of the shortened title. The join phrases component 312 identifies join phrases in each media title. A join phrase is a string that connects two significant portions of a title together. Examples of join phrases include: and the, of the, to the, -, :, etc. The join limiter component 313 contains a predefined rule that prevents certain join phrases from being considered as join phrases. The fractal split component 314 recursively splits a title at the join phrases into successively shorter substrings until the last substring contains no more join phrases. The operation of fractal splitting is illustrated in FIG. 4.

Turning briefly to FIG. 4, a flowchart depicting the process of fractal splitting is shown in accordance with an embodiment of the present invention. An exemplary media title 410 named “CRIME IN EUROPE: A GRUESOME TALE OF THE CONTOSO CLAN AND THE ITALIAN STATE” is presented. “:” is identified by join phrases component 312 as a join phrase. Assuming “:” does not contravene the rules contained in join limiter component 313, fractal split component 314 breaks the media title at “:”. Two sub-strings are generated, namely substring 420 “CRIME IN EUROPE” and substring 430 “A GRUESOME TALE OF THE CONTOSO CLAN AND THE ITALIAN STATE.” Fractal split component 314 further applies to substring 430 at the join phrase “of” to produce substrings 440 and 450. Finally, fractal split component 314 applies to substring 450 at join phrase “and” to produce substrings 460 and 470, which are free of join phrases. In the end, six substrings 420-470 are generated from the original title 410.

Turning back to FIG. 3, the next phase of the algorithm is ranking. The ranking component 315 ranks all the substrings generated in the choice generation phase according to relevance and audible criteria that correspond to the relevance 317 and audible 318 components, respectively. The relevance component 317 measures the degree of relevance a particular substring has to the original media title. The substring must capture the essence of the meaning of the original title to the extent that a viewer knows the media content to which the substring refers. The relevance component 317 also determines how unique the substring is compared to the other generated substrings as well as to other titles in the catalog. In addition, the relevance component 317 compares the substring to information in the metadata associated with the title in order to gauge relevance. Furthermore, the relevance component 317 uses search history from external search engines to understand the search query keywords that most users used to arrive at the media content to which the media title in question refers.

Search queries change with the times and therefore are better at capturing colloquial epithets or metonyms of certain titles. For instance, the movie “Dilwale Dulhania Le Jayenge” is more popularly known as “DDLJ,” which is shorter and more familiar to movie goers. Internet searches are also useful because foreign movies are sometimes phonetically translated into English thereby losing their meanings rendering it difficult to gauge the relevance of their substrings. For instance, “Wu Xia” is a phonetic translation of a Chinese movie for which the American title is “Dragon.” Therefore, Internet searches might return the name “Dragon” in response to a search query for “Wu Xia,” which is a name more familiar and more meaningful to American movie goers.

The audible component 318 measures the likelihood a speech recognition device will correctly decipher an audible command. The speech recognition device is associated with the speech recognition component 321, which translates voice into executable commands. Substrings that contain too many inaudible characters or symbols will be assigned a lower likelihood of being understood by a speech recognition device. In addition, the audible component 318 will also compare the audible quality of each substring to those of the other titles that are sharing the same screen in order to ensure that each title appearing on the screen responds to an audibly distinct command.

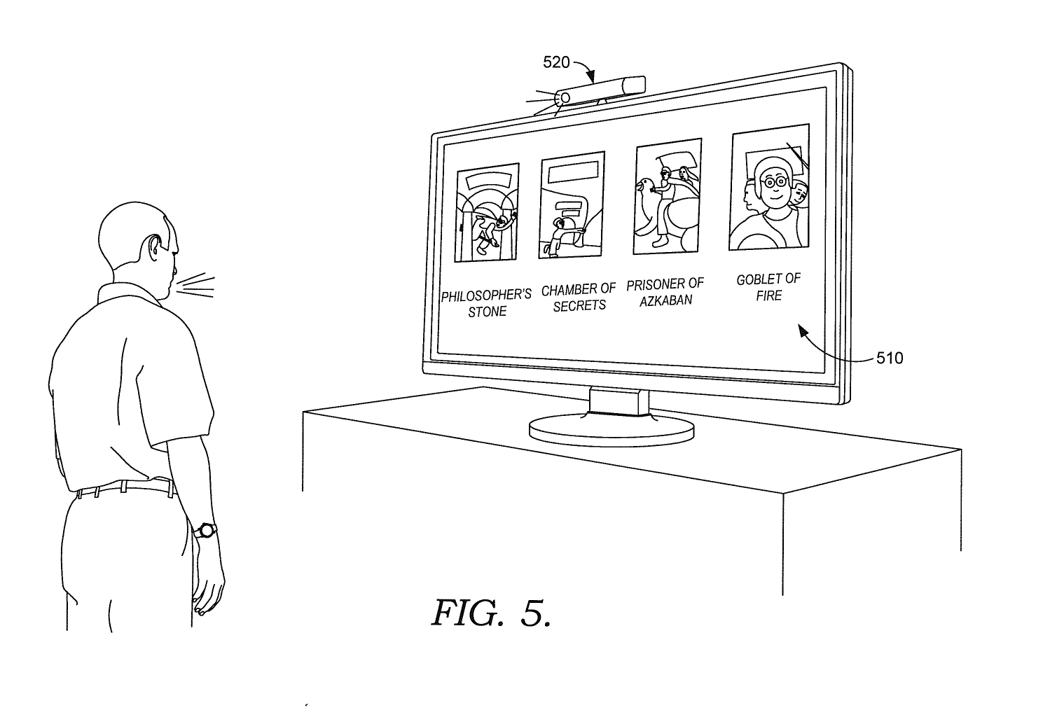

The ranking component 315 also considers the length threshold 316 imposed by the computing device. For instance, FIG. 5 shows an exemplary screen that displays four media titles 510 on the screen at the same time. Each media title is allotted a maximum space of 40 characters. In fact, the preferred length is 25 characters for greater aesthetics. Therefore, media titles longer than 40 characters must be shortened in order to fit on the screen. A movie such as “Doctor Strangelove or: How I Learned to Stop Worrying and Love the Bomb” has over 70 characters and cannot be physically accommodated on the screen without shortening. A mobile phone screen will have an even smaller length threshold given the smaller screen real estate.

Finally, selection component 319 picks the highest ranked substring amongst all possible substrings and either stores or displays the substring. In some embodiments of the present invention, the entire catalog is processed and subjected to the four-phase operation just described. The resultant shortened titles are then stored for future display when queried. In other embodiments, the four phase operation can be dynamically applied on an ad hoc basis.

Turning now to FIG. 5, a line drawing depicting an exemplary system for displaying media titles 510. There are four media titles across the screen, each with a title underneath. Due to the limited space, all titles have been shortened. All four titles are associated with the Harry Potter franchise. The original title for these movies all began with the word “Harry Potter and.” If the user has already entered a search query for Harry Potter, then it would be unnecessary to display the words “Harry Potter and” before every title because it is clear to the user from the context that all titles shown are associated with Harry Potter. FIG. 5 also shows speech recognition device 520 (e.g., Microsoft Kinect®) that receives speech commands from a user and uses the speech recognition component 321 to decipher the commands.

### Methods for Generating Shortened Titles

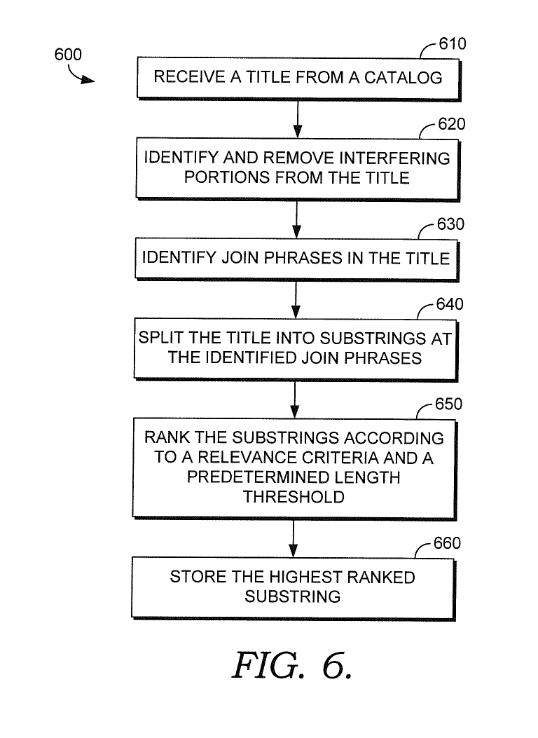

Turning now to FIG. 6, a flow diagram is illustrated showing a method 600 for generating shortened titles, in accordance with an embodiment of the present invention. At step 610, media titles in a library or catalog are received in succession. The media titles include music album, movie, TV program, book, etc. The library or catalog of media titles may be scheduled for processing when a particular system is least demanded by its users, such as overnight. In addition, each scheduled operation may process the entire catalog or just the newly added titles since the last operation.

At step 620, the interfering portions of each title are identified and then removed. Interfering portions are those portions of a title that contain redundant information that does not add to the understanding of the title and, in addition, can potentially cause confusion or ambiguity to the user.

At step 630, join phrases are identified in the title. A join phrase is a string that connects two significant portions of a title together. Some significant portions may capture the essential meaning of the original title and therefore are ideal candidates for short titles.

At step 640, the title is repeatedly split at the identified join phrases. The resultant substrings may themselves contain join phrases and therefore are also split accordingly. The process repeats until the last generated substring no longer contains join phrases.

At step 650, the generated substrings are ranked according to a relevance criteria and a predetermined length threshold. The length threshold varies from device to device depending on the size of the display screen allotted to displaying media titles. The relevance criteria gauge how relevant the substring is to the meaning of the original title by considering metadata or Internet sources. All possible strings generated from step 640 that are within the predetermined length threshold are ranked from most relevant to least relevant.

At step 660, the substring ranked the most relevant in step 650 is stored for subsequent display.

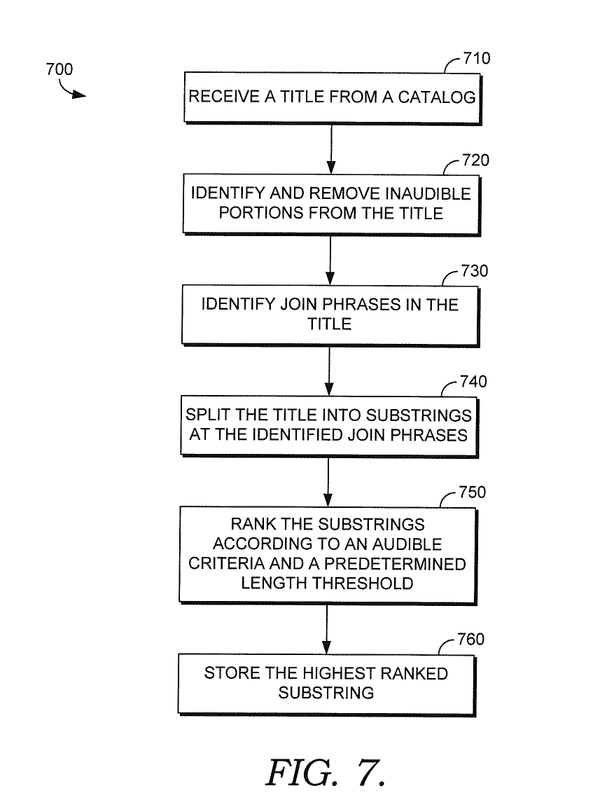

Turning now to FIG. 7, a flow diagram is illustrated showing a method 700 for generating audibly intelligible shortened titles, in accordance with an embodiment of the present invention. Step 710 receives media titles from a library or catalog. Step 720 identifies and removers inaudible portions of each title. Inaudible portions are those that cannot be pronounced by a user and consequently cannot be understood by a speech recognition device. Step 730 identifies join phrases in the title. Step 740 splits the title repeatedly at the identified join phrases until no substring contains any join phrases. Step 750 ranks substrings generated by step 740 according to an audible criteria and a predetermined length threshold. The audible criteria gauge how likely a user will be able to clearly vocalize and a speech recognition device will accurately understand a substring. In addition, the audible criteria compare the likelihood that a substring will be confused with another title appearing on the screen by the speech recognition device. All possible strings generated from step 740 that are within the predetermined length threshold are ranked from most audible to least audible. Finally, step 760 stores the substring ranked the most audible in step 750 for subsequent display.

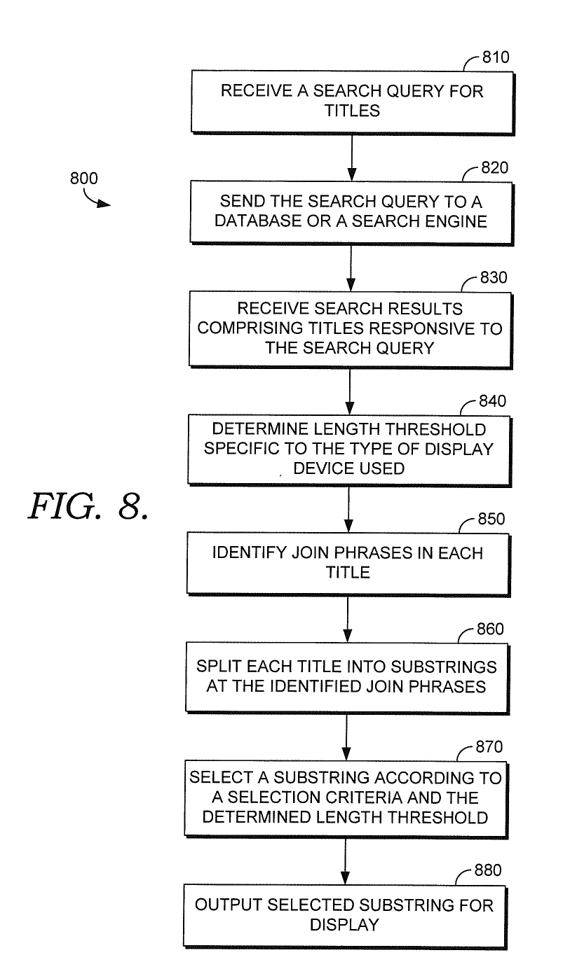

Turning now to FIG. 8, a flow diagram is illustrated showing a method 800 for generating shortened titles, in accordance with an embodiment of the present invention. Step 810 receives a search query for media titles. For instance, a user types or speaks via an input device a search query for certain media titles. Step 820 sends the search query to an internal database or an external search engine which in turn returns search results comprised of media titles. Step 830 receives the search results and processes each in succession. Step 840 determines the predetermined length threshold for media titles. Different display devices have different restrictions on the amount of space allotted to displaying media titles. A device cannot accommodate a title whose length exceeds the length threshold. Step 850 identifies join phrases in each title. Step 860 splits each title repeatedly at the identified join phrases until no substring contains any join phrases. Step 870 selects a substring within the predetermined length threshold according to a selection criteria. The selection criteria includes the aforementioned relevance criteria and audible criteria. Step 880, outputs the selected substring for display.

Embodiments of the invention have been described to be illustrative rather than restrictive. It will be understood that certain features and subcombinations are of utility and may be employed without reference to other features and subcombinations. This is contemplated by and is within the scope of the claims.

The invention claimed is:

1. One or more computer-storage media having computer-executable instructions embodied thereon that when executed by a computing device perform a method of generating for display a meaningful shortened title, the method comprising:
receiving a title of a media content from a catalog;
identifying one or more interfering portions of the title according to a cultural information associated with the title;
removing the one or more interfering portions from the title;
identifying in the title one or more join phrases that connect two or more significant portions of the title together;
splitting the title at the one or more join phrases into one or more sub-strings according to a join limiter, which is a predefined rule that prevents splitting at certain join phrases;
ranking the one or more sub-strings according to a relevance criteria and a predetermined length threshold; and
storing for display a highest ranked sub-string as a shortened title.

2. The media of claim 1, wherein the media content comprises music album, music track, movie, TV program, book, magazine, and application software.

3. The media of claim 1, wherein the one or more interfering portions offer redundant information and do not add to an understanding of the title.

4. The media of claim 1, wherein the cultural information specifies certain characters and symbols that are interfering in a particular culture or locale, the cultural information is gathered from a set of data comprising a metadata associated with the title, a metadata associated with other titles in the catalog that are closest in nature to the title being processed, and one or more search results obtained from an external search engine.

5. The media of claim 1, wherein the splitting the title at the one or more join phrases continues recursively until a last sub-string no longer contains any join phrases.

6. The media of claim 1, wherein the relevance criteria comprises a uniqueness compared to other titles in the catalog and a similarity compared to external search engine user queries that successfully returned one or more links to sites pertaining to the media content of the title.

7. The media of claim 1, wherein the predetermined length threshold is determined by a size of a screen space allotted to displaying media titles.

8. One or more computer-storage media having computer-executable instructions embodied thereon that when executed by a computing device perform a method of generating an audibly intelligible shortened title for issuance as a command to a speech recognition device, the method comprising:
receiving a title of a media content from a catalog;
identifying in the title one or more join phrases that connect two or more significant portions of the title together;
splitting the title at the one or more join phrases into one or more sub-strings;
ranking the one or more sub-strings according to an audible criteria and a predetermined length threshold; and
storing for display a highest ranked sub-string as a shortened title.

9. The media of claim 8, the method further comprising:
identifying one or more interfering or inaudible portions of the title according to a cultural information associated with the title; and
removing the one or more interfering or inaudible portions from the title.

10. The media of claim 9, wherein the one or more interfering portions offer redundant information and do not add to an understanding of the title;
the one or more inaudible portions cannot be easily pronounced by a user or are not audibly intelligible to the speech recognition device.

11. The media of claim 9, wherein the cultural information specifies certain characters and symbols that are interfering in a particular culture or locale, the cultural information is gathered from a set of data comprising a metadata associated with the title, a metadata associated with other titles in the catalog that are closest in nature to the title being processed, and one or more search results obtained from an external search engine.

12. The media of claim 8, wherein the splitting is performed according to a join limiter, which is a predetermined rule that prevents splitting at certain join phrases.

13. The media of claim 12, wherein the splitting the title at the one or more join phrases continues recursively until a last sub-string no longer contains any join phrases.

14. The media of claim 8, wherein the media content comprises music album, music track, movie, TV program, book, magazine, and application software.

15. The media of claim 8, wherein the audible criteria comprises an amount of pronounceable characters and symbols in a sub-string and an amount of distinction between an audible quality of a sub-string and an audible quality of one or more other titles displayed on a same screen.

16. The media of claim 1, wherein the predetermined length threshold is determined by a size of a screen space allotted to displaying media titles.

17. A method of generating a meaningful shortened title, the method comprising:
receiving a search query from a computing device having display characteristics;
sending the search query to a catalog or an external search engine;
receiving search results comprising one or more media titles from the catalog or the external search engine;
determining a threshold display length for media titles based on the display characteristics;
identifying in the title one or more join phrases that connect two or more significant portions of the title together;
splitting the title at the one or more join phrases into one or more substrings;
selecting a substring from the one or more substrings according to a selection criteria and the threshold display length; and
outputting for display the selected substring as a shortened title.

18. The media of claim 17, wherein the computing device comprise game console, personal computer, tablet, and mobile phone.

19. The media of claim 17, wherein the one or more media titles describe one or more of a music album, music track, movie, TV program, book, magazine, and application software.

20. The media of claim 17, wherein the display characteristics comprise a size of a screen space allotted to displaying media titles, a resolution of the computing device, and a number of search results simultaneously displayed on the computing device.
